(19) United States
(12) Patent Application Publication
(10) Pub. No.: US 2009/0142500 A1
(43) Pub. Date: Jun. 4, 2009

(54) Functional water, method for manufacturing functional water and method for manufacturing ceramics film

(75) Inventor: Takeshi Kijima, Matsumoto-shi (JP)

Correspondence Address: Edwards Angell Palmer & Dodge LLP, P.O. Box 55874, Boston, MA, 02205, US

(73) Assignee: Seiko Epson Corporation, Tokyo (JP)

(21) Appl. No.: 12/150,577

(22) Filed: Apr. 28, 2008

(30) Foreign Application Priority Data
Apr. 26, 2007 (JP) 2007-117002

(51) Int. Cl. B05D 3/04; C09K 3/00

(52) U.S. Cl. 427/377; 252/182.12

(57) ABSTRACT

Functional water includes water and alcohol, wherein a peak originated from OH groups of the water and a peak originated from OH groups of the alcohol in ¹H-NMR analysis at 50° C. form a single peak.

The entire disclosure of Japanese Patent Application No. 2007-117002, filed Apr. 26, 2007 is expressly incorporated by reference herein.

### BACKGROUND

1. Technical Field

The present invention relates to functional water, a method for manufacturing functional water, and a method for manufacturing ceramics films.

2. Related Art

In recent years, researches on the microstructure and various physical properties of liquid have been vigorously conducted. However, compared to gas and solid, there is no established analysis method for liquid, such as, electron microscopy and X-ray analysis. Therefore, in effect, the structure of liquid has not been sufficiently clarified.

It has been found by the inventor of the present application that water containing alcohol obtained by a specific method has very interesting characteristics, which are entirely different from those of a mixture of alcohol and water.

Incidentally, ferroelectric memories (FeRAM) are highly expected as one of the next generation memories. Also, ink jet printers are known as printers that enable high image quality and high speed printing. Ceramics films composed of ferroelectric and piezoelectric can be used for ferroelectric memories and heads of ink jet printers. Normally, the process for forming the ceramics films includes a heat treatment step that is conducted at high temperatures (for example, about 600° C. to 850° C.) (see, for example, JP-A-2001-223404).

### SUMMARY

In accordance with an advantage of some aspects of the invention, functional water containing alcohol and a method for manufacturing the same can be provided. In accordance with another advantage of some aspects of the invention, a method for manufacturing a ceramics film that can be formed at lower temperatures can be provided.

In accordance with an embodiment of the invention, functional water includes water and alcohol, wherein a peak originated from OH groups of the water and a peak originated from OH groups of the alcohol in ¹H-NMR analysis at 50° C. form a single peak.

In the functional water in accordance with an aspect of the present embodiment, the single peak may have a chemical shift value between a chemical shift value originated from OH groups of water and a chemical shift value originated from OH groups of alcohol in a mixed liquid of the water and the alcohol in ¹H-NMR analysis at 50° C.

In the functional water in accordance with an aspect of the present embodiment, the alcohol may be ethanol, and the chemical shift value of the single peak may be 4.48 ppm.

The functional water in accordance with an aspect of the present embodiment may further contain dissolved oxygen of 40 to 100 mg/liter.

In the functional water in accordance with an aspect of the present embodiment, the carbon number of the alcohol may be 1 to 4.

In the functional water in accordance with an aspect of the present embodiment, its solidification point obtained by a differential scanning calorimetry (DSC) is lower than a solidification point of a mixed liquid of water and alcohol.

In the functional water in accordance with an aspect of the present embodiment, its melting and solidification enthalpy obtained by DSC may be smaller than melting and solidification enthalpy of a mixed liquid of water and alcohol.

In accordance with an embodiment of the invention, a method for manufacturing functional water includes the steps of: introducing a source material gas containing water and alcohol in a gas mixing section; and liquefying the gas discharged from the gas mixing section in a condensation section to obtain functional water, wherein the gas mixing section includes a plurality of gas chamber sections, in which adjacent ones of the gas chamber sections are connected through a plurality of through-flow pipes, and the source material gas is mixed in repeated compressions and collisions while passing through the gas chamber sections and the through-flow pipes.

In the method for manufacturing functional water in accordance with an aspect of the embodiment of the invention, adjacent upper and lower sets of the plurality of through-flow pipes on each of the gas chambers may not overlap each other in a plan view.

In the method for manufacturing functional water in accordance with an aspect of the embodiment of the invention, the source material gas may further include oxygen.

A method for manufacturing a ceramics film in accordance with an embodiment of the invention includes the steps of: forming a material layer above a base substrate; introducing a source material gas containing water, alcohol and oxygen in a gas mixing section; and heating the gas in the gas mixing section and supplying the gas in an oxidation furnace, thereby oxidizing the material layer, wherein the gas mixing section includes a plurality of gas chamber sections, in which adjacent ones of the gas chamber sections are connected through a plurality of through-flow pipes, and the source material gas is mixed in repeated compressions and collisions while passing through the gas chamber sections and the through-flow pipes.

In the method for manufacturing a ceramics film in accordance with an aspect of the embodiment, the step of forming the material layer may include coating above the base substrate a solution containing a source material solution for the ceramics film, and applying a heat treatment to the solution coated.

According to the method for manufacturing a ceramics film described above, the ceramics film can be formed at lower temperatures, compared to the ordinary method for manufacturing a ceramics film.

In the method for manufacturing a ceramics film in accordance with an aspect of the embodiment of the invention, the temperature of the base substrate may be between 200° C. and 500° C. in the step of oxidizing the material layer.

In the description of the invention, the term “above” is used, for example, as in a statement “a specific component (hereinafter called ‘B’) is laminated “above” another specific component (hereinafter called ‘A’).” In such a case, the term “above” is used in the description of the invention, while assuming to include the case where the component B is laminated directly on the component A and the case where the component B is laminated over the component A through another component provided on the component A.

### BRIEF DESCRIPTION OF THE DRAWINGS

FIG. 1 is a schematic diagram showing a method for manufacturing functional water and a manufacturing apparatus used for the method in accordance with an embodiment of the invention.

FIG. 2 is a schematic diagram of an apparatus for manufacturing functional water.

FIG. 3 is a schematic diagram of an apparatus for manufacturing functional water in accordance with a modified example.

FIG. 4 is a chart showing ¹H-NMR analysis results of water obtained by the manufacturing apparatus shown in FIG. 1.

FIG. 5 is a chart showing ¹H-NMR analysis results of purified water.

FIG. 6 is a chart showing ¹H-NMR analysis results of functional water.

FIG. 7 is a chart showing ¹H-NMR analysis results of a mixed liquid of purified water and alcohol.

FIG. 8 is a graph showing DSC measurement results of functional water and the mixed liquid.

FIG. 9 is a cross-sectional view schematically showing a step of a manufacturing method for forming a ceramics film in accordance with an embodiment of the invention.

FIG. 10 is a cross-sectional view schematically showing a manufacturing method and manufacturing apparatus for forming a ceramics film in accordance with the embodiment of the invention.

FIG. 11 is a cross-sectional view schematically showing a step of the manufacturing method for forming a ceramics film in accordance with the embodiment of the invention.

FIG. 12 is a graph showing X-ray analysis results of a ceramics film.

FIG. 13 is a graph showing X-ray analysis results of a ceramics film.

### DESCRIPTION OF EXEMPLARY EMBODIMENTS

Preferred embodiments of the invention are described below with reference to the accompanying drawings.

1. Functional Water and its Manufacturing Method

1.1. Method for Manufacturing Functional Water

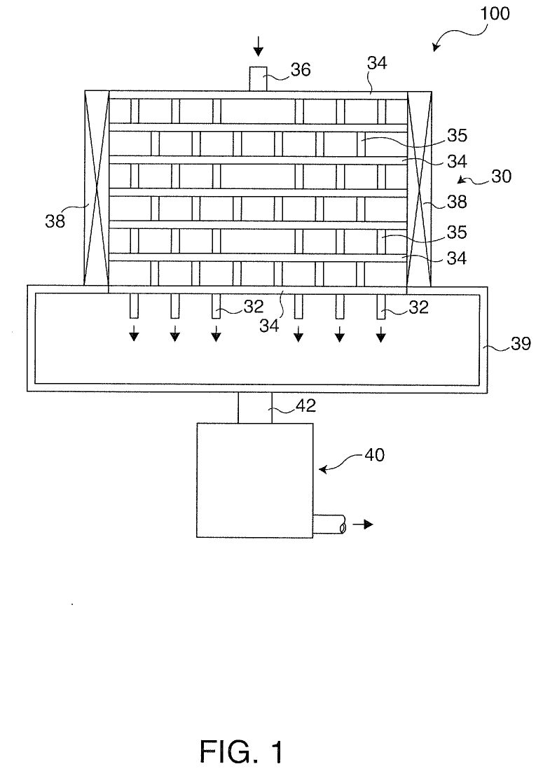

First, a method for manufacturing functional water in accordance with an embodiment of the invention is described. FIG. 1 is a view schematically showing a method for manufacturing functional water and a manufacturing apparatus 100 for manufacturing functional water in accordance with an embodiment of the invention.

As shown in FIG. 1, the manufacturing apparatus 100 for manufacturing functional water includes a gas mixing section 30 and a condensation section 40 connected to the gas mixing section 30.

The gas mixing section 30 includes a plurality of gas chamber sections 34, a plurality of through-flow pipes 35, an inlet section 36, supply pipes 32, a gas container section 39, and a heating section 38. Gas of functional water is discharged through the supply pipes 32. The functional water shall be described in detail below. Each of the supply pipes 32 may be formed from an elongated cylindrical tube, for example. It is noted that the supply pipes 32 may be each in a tubular shape in the illustrated example. However, opening sections may be provided in a bottom surface of the gas chamber section 34 at the lowermost stage, and the opening sections may be used as the supply tubes.

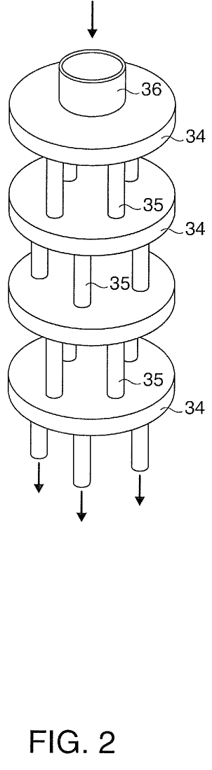

The multiple gas chamber sections 34 are disposed at intervals over the supply tubes 32. In the example shown in FIG. 1, the gas chamber sections 34 are formed in seven stages. However, the number of stages may be increased or decreased depending on necessity without any particular limitation. The plural through-flow pipes 35 connect the gas chamber sections 34 to one another. The number of through-flow pipes 35 disposed in each stage may be increased or decreased depending on necessity without any particular limitation. As shown in FIG. 2, upper and lower ones of the through-flow pipes 35 adjacent to each of the gas chamber sections 34 may not overlap each other in a plan view. Also, upper and lower ones of the through-flow pipes 35 adjacent to each of the gas chamber sections 34 may be displaced with respect to one another in a plan view. In the illustrated example, the upper set and the lower set of the through-flow pipes 35 are displaced through 45 degrees with respect to each other about the center of the gas chamber sections 34 in a plan view. It is noted that FIG. 2 is a perspective view schematically showing the main portion of the manufacturing apparatus 100, in which the number and the size of members and the like are simplified for the sake of convenience. The gas chamber section 34 may be a flat columnar tube, for example, as shown in the figure. Each of the through-flow pipes 35 may be a long and narrow columnar tube, for example, as shown in the figure. The diameter of the gas chamber section 34 in a plan view is greater than the diameter of the through-flow pipe 35 in a plan view, as shown in the figure. It is noted that the shape and the size of the gas chamber section 34 and the through-flow pipe 35 are not limited to those of the example shown in the figure, and may be changed depending on necessity.

A source material gas containing at least water and alcohol is introduced into the inlet section 36. Depending on the usage of the functional water, the source material gas may include other substance. For example, the source material gas may further include oxygen, hydrogen and/or nitrogen. The inlet section 36 may be a columnar tube, for example, as shown in the figure. The heating section 38 can heat the plural gas chamber sections 34 and the plural through-flow pipes 35.

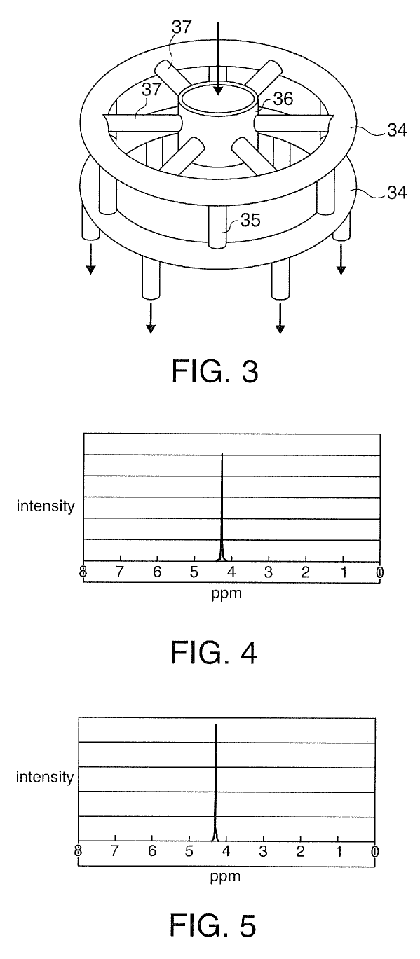

The gas chamber sections 34 and the through-flow pipes 35 may have, for example, the configuration and arrangement shown in FIG. 3. FIG. 3 is a perspective view schematically showing a modified example of the main portion of the manufacturing apparatus 100, in which the number and size of the members are simplified for the sake of convenience. The gas chamber section 34 may be a circular tube, for example, as shown in the figure. The outer diameter of the gas chamber section 34 in a plan view is greater than the diameter of the through-flow pipe 35 in a plan view, as shown in the figure. In the illustrated example, upper and lower sets of the plural through-flow pipes 35 with respect to each of the gas chamber sections 34 are displaced through 45 degrees with respect to each other about the center of the gas chamber sections 34 in a plan view. The gas chamber section 34 in the uppermost stage is connected with the inlet section 36 through a plurality of (six in the example shown in the figure) connecting tubes 37. The inlet section 36 may be a columnar tube closed at its bottom, as shown in FIG. 3, for example. The connecting tubes 37 are radially disposed around the inlet section 36 in a plan view. It is noted that this modified example is only an example, and the invention is not limited to this modified example.

The condensation section 40 is connected to the gas storage section 39 of the gas mixing section 30 through a coupling tube 42. In the condensation section 40, the gas is cooled, for example, through thermal exchange using refrigerant, whereby the gas is liquefied. The gas may be liquefied in the condensation section 40 by any known method, such as, cooling or the like, without any particular limitation. The liquefied functional water at the condensation section 40 can be retrieved from the discharge pipe 44. Although not shown, valves or the like may be installed on the coupling tube 42 and the discharge pipe 44.

Next, a method for manufacturing functional water using the above-described manufacturing apparatus 100 is described with reference to FIG. 1.

The method for manufacturing functional water in accordance with the present embodiment includes the steps of introducing a source material gas containing at least water and alcohol into the gas mixing section 30, and liquefying the gas discharged from the gas mixing section 39 in the condensation section 40, thereby obtaining functional water.

For introducing the source material gas into the gas mixing section 30, the source material gas is first led into the inlet section 36. The gas inside the inlet section 36 is supplied to the gas chamber section 34 disposed at the topmost stage. In this instance, the gas discharged from the inlet section 36 collides against the bottom surface of the gas chamber section 34 and is diffused. Then the gas is supplied through the plural through-flow pipes 35 connected to the gas chamber section 34 at the topmost stage to the gas chamber section 34 disposed in the next stage while being compressed. In this instance, the gas discharged from the plural through-flow pipes 35 also collide against the bottom surface of the gas chamber section 34 and is diffused. In this manner, the gas introduced into the inlet section 36 can flow from the gas chamber section 34 at the topmost stage to the gas chamber section 34 at the lowermost stage while repeatedly colliding against the bottom surface of each of the gas chamber sections 34 and compressed by the through-flow pipes 35.

The gas chamber sections 34 and the through-flow pipes 35 are heated by the heating section 38, and the gas flowing inside is also heated. The gas that has flowed from the gas chamber section 34 at the topmost stage to the gas chamber section 34 at the lowermost stage is discharged through the supply pipes 32 into the gas storage section 39 as an active gas. Then, the gas inside the gas storage section 39 is supplied through the coupling pipe 42 to the condensation section 40, where the gas is liquefied by an appropriate method such as cooling, thereby obtaining functional water. The functional water formed inside the condensation section 40 can be retrieved through the discharge pipe 44.

1.2. Functional Water

Next, functional water in accordance with an embodiment of the invention, which is obtained by the manufacturing method described above, is described.

Functional water in accordance with the present embodiment includes water and alcohol, wherein a peak originated from OH groups of the water and a peak originated from OH groups of the alcohol in ¹H-NMR analysis at 50° C. form a single peak. In the functional water in accordance with the present embodiment, the single peak may have a chemical shift value between a chemical shift value originated from OH groups of water and a chemical shift value originated from OH groups of alcohol in a mixed liquid of the water and the alcohol in ¹H-NMR analysis at 50° C.

It is understood that the functional water in accordance with the present embodiment has the characteristic described above in ¹H-NMR analysis, and therefore is different from a mere mixed solution of alcohol and water. This characteristic is more concretely described below referring to charts showing the ¹H-NMR analysis results.

FIG. 4 is a chart of water obtained by the manufacturing apparatus 100 shown in FIG. 1, in which only water without containing alcohol was used as a source material gas. FIG. 5 shows a chart of purified water for comparison. For example, ion-exchange water may be used as the purified water. It is observed from FIG. 4 and FIG. 5 that the water obtained by using the manufacturing apparatus 100 and the purified water have almost the same chemical shift value (4.24 ppm).

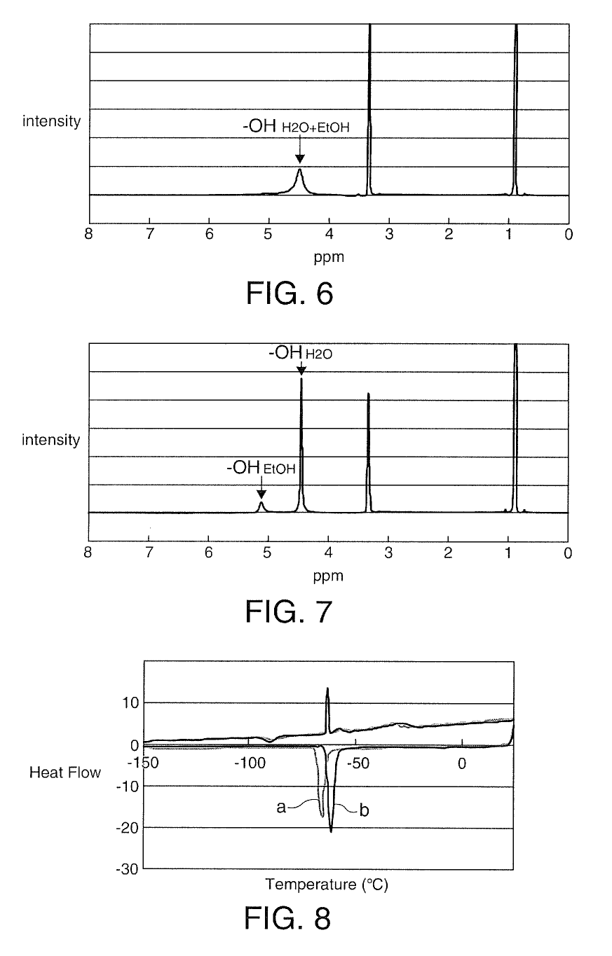

FIG. 6 shows a chart of the functional water in accordance with the present embodiment. More specifically, the functional water was obtained by the manufacturing method in accordance with the present embodiment described above, using water and alcohol as source material gas. As a sample that resulted in the chart shown in the figure, ethanol and water in a mole ratio of 1:2 were used as the source material gas. It is observed from FIG. 6 that the functional water has a single peak that originates from OH groups, and its chemical shift value is 4.48 ppm.

In contrast, FIG. 7 is a chart of a mixed liquid of purified water and ethanol. As a sample that resulted in the chart shown in the figure, ethanol and purified water in a mole ratio of 1:2 were used. It is observed from FIG. 7 that the mixed liquid has two peaks originated from OH groups. The chemical shift value of the peak originated from OH groups of water was 4.45 ppm, and the chemical shift value of the peak originated from OH groups of ethanol was 5.11 ppm.

The following observation can be made in light of the above. Because the mixed liquid of purified water and alcohol has peaks originated from their respective OH groups, they are separated in the molecule level or in the cluster level. In contrast, the functional water in accordance with the present embodiment has a single peak originated from OH groups, and therefore it is believed that water and alcohol has a structure in which they are bonded together at least in the cluster level. In other words, it is believed that the functional water in accordance with the present embodiment has a structure in which a portion of clusters of water is replaced with alcohol, or a structure in which a portion of clusters of alcohol is replaced with water.

FIG. 8 is a graph showing solidification and melting enthalpy measured by a DSC method. In FIG. 8, a chart indicated by a sign a is a chart of functional water in accordance with the present embodiment, and a chart indicated by a sign b is a chart of mixed liquid of purified water and alcohol for comparison. The functional water was obtained, using water and alcohol as source material gas, by the manufacturing method in accordance with the present embodiment described above. As a sample of the functional water that resulted in the chart shown in the figure, ethanol and water in a mole ratio of 1:2 were used as the source material gas. As the mixed liquid of alcohol and purified water, ethanol and purified water in a mole ratio of 1:2 were used.

It is observed that the peak indicating the solidification enthalpy of the functional water in accordance with the present embodiment appears on a lower temperature side than the peak indicating the solidification enthalpy of the mixed liquid of purified water and ethanol. It is understood from this result that the functional water in accordance with the present embodiment exhibits a lower solidification point that is obtained by the DSC measurement, compared to the mixed liquid of water and ethanol.

It is observed from FIG. 8 that the area of the peak indicating solidification and melting enthalpy of the functional water in accordance with the present embodiment is smaller than the area of the peak indicating solidification enthalpy of the mixed liquid of purified water and ethanol. More specifically, the melting enthalpy of the functional water was 86.5 J/g, and the melting enthalpy of the mixed liquid was 109.1 J/g. Also, the solidification enthalpy of the functional water was 63.1 J/g, and the solidification enthalpy of the mixed liquid was 74.9 J/g. It is understood from this result that the functional water in accordance with the present embodiment has a greater apparent molecular weight of clusters compared to the mixed liquid.

The functional water in accordance with the present embodiment may further contain substance other than water and alcohol depending on its usage. For example, when the source material gas contains oxygen, the functional water may contain dissolved oxygen of 40 to 100 mg/1. Dissolved oxygen contained in water is normally 3-4 mg/1. In this respect, the functional water in accordance with the present embodiment can contain oxygen in an extremely high concentration.

In the functional water in accordance with the present embodiment, the carbon number of the alcohol may be 1-4. Further, the ratio of alcohol and water contained in the functional water is not particularly limited, and they can be mixed at any ratio depending on the usage.

The functional water in accordance with the present embodiment is useful in a variety of uses and industrial fields, such as, for example, foods including beverages, medicines, industrial water, agricultural water and the like. For example, the functional water containing oxygen may be used in steam oxidation to be described below, whereby the crystallization temperature of piezoelectric or ferroelectric can be considerably lowered.

2. Method for Manufacturing Ceramics Film

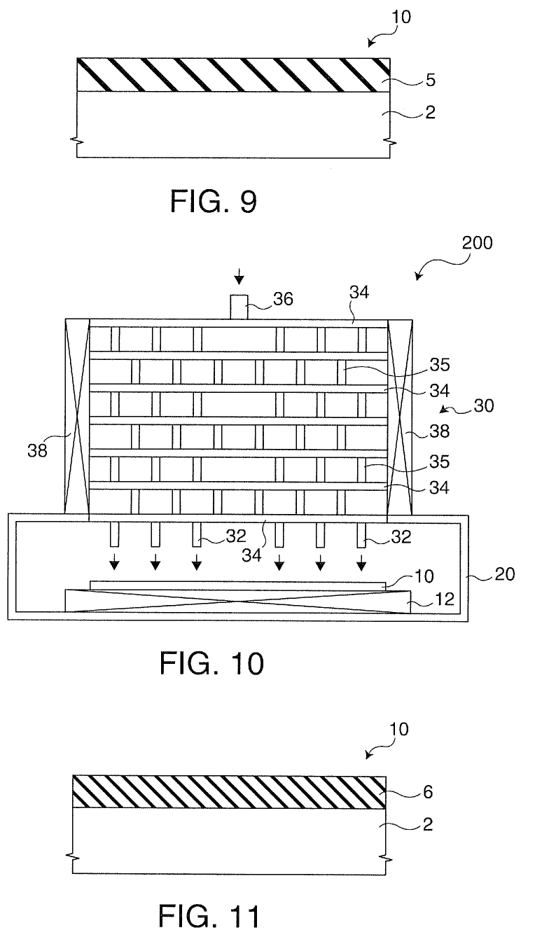

FIGS. 9 to 11 are cross-sectional views schematically showing steps of a manufacturing method for forming a ceramics film in accordance with an embodiment of the invention. FIG. 10 is a cross-sectional view schematically showing a manufacturing apparatus 200 used for the method for forming a ceramics film in accordance with the present embodiment.

The manufacturing method for forming a ceramics film in accordance with the present embodiment is described below.

(A) First, as shown in FIG. 9, a material layer 5 for forming a ceramics film is laminated on a base substrate 2. As the base substrate 2, any appropriate substrate may be used without any particular limitation, and for example, a semiconductor substrate, a resin substrate or a base substrate in which a dielectric layer or a conductive layer is laminated on the aforementioned substrate may be used. As a conductive layer (lower electrode), any layer may be used without any particular limitation, and for example, a platinum (Pt) film, a film in which a layer of conducive oxide with a perovskite structure (for example, LaNiO₃, SrRuO₃ or the like) is laminated on a platinum layer, or the like may be used. The conductive layer may be formed by, for example, a sputter method, a spin coat method, a CVD method, a laser ablation method or the like.

The material layer 5 may be formed as follows. A solution is prepared by mixing a plurality of source material solutions at a desired ratio that causes the resulting ceramics film to have a desired composition ratio, and the solution is coated on the base substrate 2 by using, for example, a spin coat method (mixed solution coating step). The source material solution may be prepared by mixing organometals including constituent metals composing the ceramic film in a manner that the respective metals are contained in a desired mole ratio, and dissolving or dispersing the mixture in an organic solvent such as an alcohol (for example, n-butanol or the like). When using lead zirconate titanate niobate (Pb (Zr, Ti, Nb)O₃) (hereinafter also called “PZTN”) as the ceramic film, Pb, Zr, Ti, and Nb are constituent metals of the material for forming the ceramic film. As the organometals, for example, metal alkoxides, organic acid salts or the like may be used. It is noted that the ceramic film is not limited to PZTN. For example, various oxides, such as, lead zirconate titanate (Pb (Zr, Ti)O₃: PZT) may also be used.

Various additives, such as, a stabilizer may be added to the source material solution depending on necessity. When hydrolysis and polycondensation are to be caused in the source material solution, an acid or a base may be added to the source material solution as a catalyst together with an appropriate amount of water.

The source material solution is then subjected to heat treatment in an air-atmosphere using a hot plate or the like at a temperature (for example, 150° C.) higher than the boiling point of the solvent used for the source material solution by, for example, about 10° C. (drying heat treatment step).

The source material solution is then subjected to heat treatment in an air-atmosphere using a hot plate or the like at about 300° C. to 350° C., for example, in order to decompose and remove ligands of the organometals used for the source material solution (cleaning heat treatment step).

A series of steps including the mixed solution coating step, the drying heat treatment step, and the cleaning heat treatment step may be repeatedly performed an appropriate number of times depending on the desired film thickness.

A laminate 10, in which the material layer 5 is formed on the base substrate 2, is obtained by the above-described steps, as shown in FIG. 9.

(B) Next, as shown in FIG. 10 and FIG. 11, a ceramics film 6 is formed using a manufacturing apparatus 200 for forming a ceramics film. In the manufacturing apparatus 200, components that are substantially the same as those of the manufacturing apparatus 100 shown in FIG. 1 are appended with the same reference numerals, and their detailed description is omitted.

The manufacturing apparatus 200 used for forming a ceramics film in accordance with the present embodiment includes an oxidation furnace 20, a base substrate mounting section 12 and a gas mixing section 30.

The base substrate mounting section 12 is provided in the oxidation furnace 20. The base substrate mounting section 12 is capable of mounting a base substrate 2 (laminate 10) laminated with a material layer 5 thereon formed by the process described above. The base substrate mounting section 12 may be equipped with a heater. The laminate 10 can be heated by the heater.

The gas mixing section 30 is provided above the base substrate mounting section 12. The gas mixing section 30 has generally the same structure as that of the manufacturing apparatus 100 shown in FIG. 1. In other words, the gas mixing section 30 includes supply pipes 32, a plurality of gas chamber sections 34, a plurality of through-flow pipes 35, an inlet section 36 and a heating section 38. Active oxidizing gas is discharged (supplied) from the supply pipes 32 toward the base substrate mounting section 12. The active oxidizing gas may include, for example, water, alcohol and oxygen. The oxidizing gas, when liquefied, becomes functional water in accordance with the present embodiment containing oxygen in high concentration.

By using the manufacturing apparatus 200 for forming a ceramics film described above, a ceramics film 6 is formed. More specifically, first, a base substrate 2 having a material layer 5 laminated thereon (laminate 10), as shown in FIG. 11, is set on the base substrate mounting section 12. Then, a source material gas containing steam, alcohol gas and oxygen gas is introduced in the gas mixing section 30. The source material gas is initially introduced in the inlet section 36. The source material gas inside the inlet section 36 is supplied to the gas chamber section 34 disposed at the topmost stage. In this instance, the gas discharged from the inlet section 36 collides against the bottom surface of the gas chamber section 34 thereby being diffused. Then the gas is supplied through the plural through-flow pipes 35 connected to the gas chamber section 34 at the topmost stage to the gas chamber section 34 disposed in the next stage while being compressed. In this instance, the gas discharged from the plural through-flow pipes 35 also collide against the bottom surface of the gas chamber section 34 and is diffused. In this manner, the gas introduced into the inlet section 36 can flow from the gas chamber section 34 at the topmost stage to the gas chamber section 34 at the lowermost stage while repeatedly colliding against the bottom surface of each of the gas chamber sections 34 and compressed by the through-flow pipes 35.

The gas chamber sections 34 and the through-flow pipes 35 are heated by the heating section 38. The gas that has flowed from the gas chamber section 34 at the topmost stage to the gas chamber section 34 at the lowermost stage is discharged (supplied) through the supply pipes 32 into the oxidation furnace 20 as an active oxidizing gas. The laminate 10 is heated inside the oxidation furnace 20 by the base substrate mounting section 12. In this manner, heat treatment is applied to the material layer 5 in the atmosphere of active oxidizing gas. As a result, the material layer 5 is oxidized and crystallized, thereby forming a ceramics film 6, as shown in FIG. 11. The temperature of the base substrate 2 in this heat treatment step may be, for example, between 200° C. and 500° C., and more preferably between 200° C. and 300° C.

By the steps described above, the ceramics film 6 in accordance with the present embodiment can be manufactured.

Depending on necessity, a conductive layer (upper electrode) may be formed on the ceramics film 6. The conductive film may be formed from a film that is generally the same as the conductive layer (lower electrode) described above.

Next, an embodiment example of the manufacturing method for forming a ceramics film is described below.

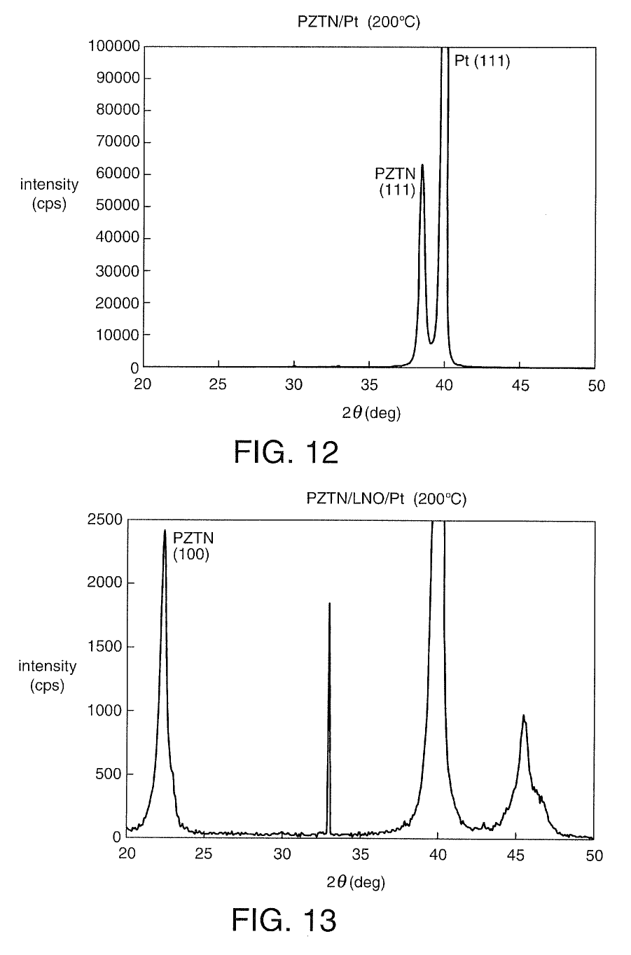

FIGS. 12 and 13 show results of X-ray diffraction measurement in an experiment conducted with the temperature of the base substrate 2 set at 200° C. FIG. 12 shows the case where platinum (Pt) with (111) orientation was used as the lower electrode, and PZTN was used as the ceramics film 6. FIG. 13 shows the case where a film of platinum (Pt) having LaNiO₃ with (100) orientation laminated thereon was used as the lower electrode, and PZTN was used as the ceramics film 6. FIGS. 12 and 13 show the results obtained when steam, alcohol gas and oxygen gas were used as the source material gas. As shown in FIGS. 12 and 13, it was confirmed that, when the temperature of the base substrate 2 in the heat treatment step was 200° C., the ceramics film 6 crystallized with excellent orientation was obtained.

In accordance with the present embodiment, the ceramics film 6 can be formed at considerably lower temperatures, compared to an ordinary known ceramics film manufacturing method, as described above, more specifically, the ceramics film 6 can be formed with the base substrate 2 being at temperatures between 200° C. and 300° C.

Only some embodiments of the invention have been described in detail above. However, the person having ordinary skilled in the art shall readily appreciate that many modifications can be made without departing in substance from the novel matter and advantages of the invention. Accordingly, all of such modifications are deemed included within the scope of the invention.

What is claimed is:

1. Functional water comprising: water; and alcohol, wherein a peak originated from OH groups of the water and a peak originated from OH groups of the alcohol in ¹H-NMR analysis at 50° C. form a single peak.

2. Functional water according to claim 1, wherein the single peak has a chemical shift value between a chemical shift value originated from OH groups of water and a chemical shift value originated from OH groups of alcohol in a mixed liquid of the water and the alcohol in ¹H-NMR analysis at 50° C.

3. Functional water according to claim 1, wherein the alcohol is ethanol, and the chemical shift value of the single peak is 4.48 ppm.

4. Functional water according to claim 1, further comprising dissolved oxygen of 40 to 100 mg/liter.

5. Functional water according to claim 1, wherein the carbon number of the alcohol is 1 to 4.

6. Functional water according to claim 1, wherein a solidification point of the functional water obtained by a differential scanning calorimetry (DSC) is lower than a solidification point of a mixed liquid of water and alcohol.

7. Functional water according to claim 1, wherein each of melting and solidification enthalpy of the functional water obtained by DSC is smaller than melting and solidification enthalpy of a mixed liquid of water and alcohol.

8. A method for manufacturing functional water, comprising the steps of:
introducing a source material gas containing water and alcohol in a gas mixing section; and
liquefying the gas discharged from the gas mixing section in a condensation section to obtain functional water,
wherein the gas mixing section includes a plurality of gas chamber sections, in which adjacent ones of the gas chamber sections are connected through a plurality of through-flow pipes, and the source material gas is mixed in repeated compressions and collisions while passing through the gas chamber sections and the through-flow pipes.

9. A method for manufacturing functional water according to claim 8, wherein upper and lower sets of the plurality of through-flow pipes with respect to each of the gas chambers do not overlap each other in a plan view.

10. A method for manufacturing functional water according to claim 8, wherein the source material gas further includes oxygen.

11. A method for manufacturing a ceramics film, comprising the steps of:
forming a material layer above a base substrate;
introducing a source material gas containing water, alcohol and oxygen in a gas mixing section; and
heating the source material gas in the gas mixing section and supplying the source material gas into an oxidation furnace, thereby oxidizing the material layer,
wherein the gas mixing section includes a plurality of gas chamber sections, in which adjacent ones of the gas chamber sections are connected through a plurality of through-flow pipes, and the source material gas is mixed in repeated compressions and collisions while passing through the gas chamber sections and the through-flow pipes.

12. A method for manufacturing a ceramics film according to claim 11, wherein the step of forming the material layer includes coating above the base substrate a solution containing a source material solution for the ceramics film, and applying a heat treatment to the solution coated.

13. A method for manufacturing a ceramics film according to claim 11, wherein the temperature of the base substrate is between 200° C. and 500° C. in the step of oxidizing the material layer.
